(19) United States
(12) Patent Application Publication
(10) Pub. No.: US 2008/0059768 A1
(43) Pub. Date: Mar. 6, 2008

(54) Method and Apparatus for Communicating a Bit Per Half Clock Cycle over at Least One Pin of an SPI Bus

(75) Inventors: Chun-Hsiung Hung, Hsinchu (TW); Yu-Lan Kuo, Hsinchu City (TW)

Correspondence Address: MACRONIX;C/O HAYNES BEFFEL & WOLFELD LLP, P. O. BOX 366, HALF MOON BAY, CA, 94019, US

(73) Assignee: Macronix International Co., Ltd., Hsinchu (TW)

(21) Appl. No.: 11/773,704

(22) Filed: Jul. 5, 2007

Related U.S. Application Data
(63) Continuation-in-part of application No. 11/771,754, now abandoned.
(60) Provisional application No. 60/806,704, filed on Jul. 6, 2006.

(51) Int. Cl. G06F 15/00

(52) U.S. Cl. 712/43

(57) ABSTRACT

Various embodiments increase the speed of communication over an SPI bus by communicating a bit per half clock cycle over at least one pin of an SPI bus.

### REFERENCE TO RELATED APPLICATION

The present application is a continuation-in-part of U.S. application Ser. No. 11/771,754 filed 29 Jun. 2007, which claims the benefit of U.S. Provisional Application No. 60/806,704 filed 6 Jul. 2006. The present application is a continuation-in-part of U.S. application Ser. No. 11/748,984 filed 15 May 2007, which claims the benefit of U.S. Provisional Application No. 60/803,782 filed 2 Jun. 2006. All of these applications are incorporated by reference.

### BACKGROUND

The Serial Peripheral Interface (SPI) bus is a well known serial interface, with one data output pin and one data input pin. Serial interfaces such as SPI have a traditional advantage over parallel interfaces, in that serial interfaces tend to have simpler connections. Also, generally increasing clock speeds over time tend to make the speed advantage of parallel interfaces less important. However, in applications where both speed and simplicity are important, it would be desirable to generally maintain the standard SPI bus, but somehow increase its speed.

### SUMMARY OF THE INVENTION

An aspect of the technology is an integrated circuit comprising a bus following a follows a Serial Peripheral Interface standard, which carries data between the integrated circuit and another integrated circuit. The bus has multiple pins, including: a first data communication pin communicating the data over the bus, a second data communication pin communicating the data over the bus, a chip select pin indicating whether the data is being communicated between the integrated circuit and another integrated circuit, and a clock pin clocking the bus with a clock signal. The bus operates in at least one operation mode, in which the first data communication pin communicates data at a rate of one bit per half cycle of the clock signal. In some embodiments, the second data communication pin also communicates data at a rate of one bit per half cycle of the clock signal.

In some embodiments, the bus also has a second operation mode, in which the first data communication pin communicates data at a rate of one bit per cycle of the clock signal. The circuit includes a mode control circuit selectively operating in multiple operation modes, such as the first and second operation modes. In various embodiments, in at least of the operation modes (such as the first operation mode or the second operation mode) the data communication pin communicates data from the integrated circuit to another integrated circuit, and/or to the integrated circuit from another integrated circuit.

In some embodiments, the bus uses dummy cycles to compensate for a delay in another integrated circuit.

Some embodiments further comprise a memory coupled to the bus.

In various embodiments, the integrated circuit is a master integrated circuit or a slave integrated circuit.

In some master integrated circuit embodiments, the multiple pins include multiple chip select pins, each of which indicates whether the data is being communicated between the master integrated circuit and a respective slave integrated circuit.

In some slave integrated circuit embodiments the chip select pin indicates whether the data is being communicated between the slave integrated circuit and a master integrated circuit.

In some embodiments, the first data communication pin and the second data communication pin communicate data in a same direction between the integrated circuit and another integrated circuit.

Another aspect of the technology is a method of communicating data between integrated circuits, comprising the steps of:

clocking, via a clock pin, a bus following a Serial Peripheral Interface standard, the bus carrying data between an integrated circuit and another integrated circuit.

communicating a chip select signal indicating whether the data is being communicated between the integrated circuit and another integrated circuit.

communicating the data over a first data communication pin and a second data communication pin of the bus between the integrated circuit and another integrated circuit, wherein the first data communication pin operates at a rate of one bit per half cycle of the clock signal in at least a first operation mode.

Other embodiments are as disclosed herein.

Another aspect of the technology is an apparatus communicating data between integrated circuits, comprising:

means for clocking a bus following a Serial Peripheral Interface standard, the bus carrying data between an integrated circuit and another integrated circuit;

means for communicating a chip select signal indicating whether the data is being communicated between the integrated circuit and another integrated circuit;

in a first mode of the bus, means for communicating the data over a first data communication pin of the bus and a second data communication pin of the bus between the integrated circuit and another integrated circuit, including:

means for communicating the data over the first data communication pin at a rate of one bit per half cycle of the clock signal.

### BRIEF DESCRIPTION OF THE DRAWINGS

FIG. 1 shows an SPI configuration with master and slave integrated circuit embodiments.

FIG. 2 shows an SPI integrated circuit timing diagram with several dummy cycles to compensate for a delay in the integrated circuit.

FIG. 3 shows an SPI integrated circuit timing diagram with more dummy cycles than in FIG. 2 to compensate for a delay in the integrated circuit.

FIG. 4 shows a flow chart showing operation of an SPI integrated circuit in an operation mode using a single pin to communicate data.

FIG. 5 shows a flow chart showing operation of an SPI integrated circuit in an operation mode using multiple pins to communicate data.

FIG. 6 shows an SPI integrated circuit timing diagram communicating data using multiple pins and at a DDR (double data rate).

FIG. 7 shows an SPI integrated circuit timing diagram communicating data using multiple pins and at a DDR (double data rate) in one direction only between the4 master and slave.

FIG. 8 shows an SPI integrated circuit timing diagram communicating data using multiple pins and at a DDR (double data rate) in one direction only between the master and slave, in particular the opposite direction from that of FIG. 7.

FIG. 9 shows an exemplary block diagram of an SPI integrated circuit that includes a nonvolatile memory array.

### DETAILED DESCRIPTION

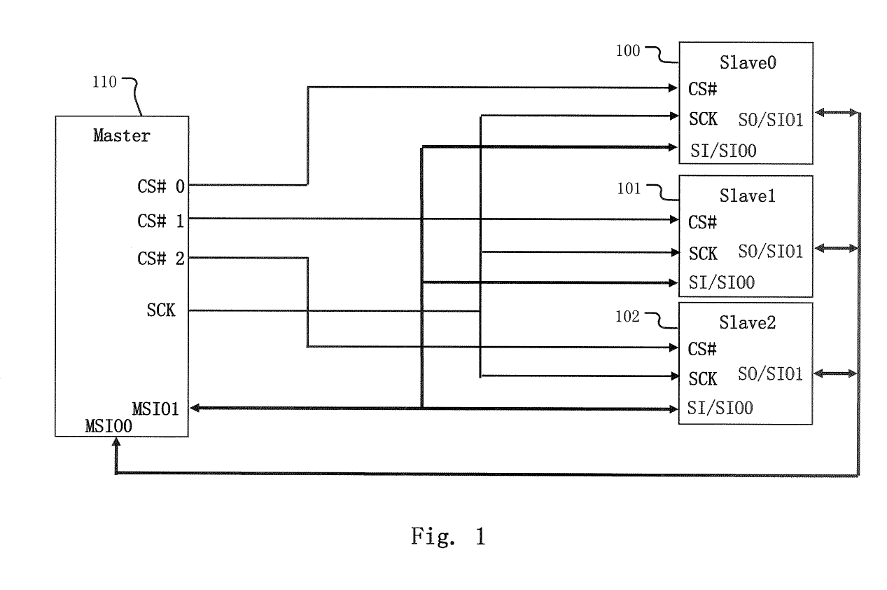

FIG. 1 shows an SPI configuration with master and slave integrated circuit embodiments.

The Serial Peripheral Interface (SPI) bus is a serial interface, specifying the signals: serial clock (SCK); master data output or slave data input (MDO/SI); master data input or slave data output (MDI/SO); and chip select (CS#). Many SPI embodiments have two configuration bits, clock polarity (CPOL) and clock phase (CPHA). Because SCK carries a separate clock signal dedicated to clocking the data of the SPI interface, SPI is a synchronous interface, i.e. that does not embed the clock signal into the data stream itself.

CPOL determines whether the shift clock's idle state is low (CPOL=0) or high (CPOL=1). CPHA determines on which clock edges data is shifted in and out (CPHA=0 MOSI data is shifted out on falling edge, MISO data is shifted in on rising edge). As each bit has two states, this allows for four different combinations. Two SPI devices talking to each other use the same clock polarity and phase settings.

Two of the four clock polarity and phase settings allow the SPI interface to talk to different Microwire devices and vice versa. Microwire is a subset of SPI, and is an embodiment of SPI. The Microwire protocol has fixed clock polarity and clock phase, as follows: SI is latched (data shifted in) on the rising edge of the SCK clock and SO changes (data shifted out) on the falling edge. SK is always low if no data is transmitted.

An embodiment of an SPI interface modifies the SI and SO pins for higher access speed operation. Rather than dedicating the input pin (SI) only for instruction/address input, and the output pin (SO) only for data/status output, both the SO pin and the SI pin perform input at the same time, or output at the same time. During the instruction/address input phase, both the SO and SI pins are regarded as input pins and receive the input data from the master device. During the data output phase, both the SO and SI pins are regarded as output pins and transmit data to the master device. Because the SI and SO pins play roles as both the input and output pin, they are referred to herein as SI/SIO0 and SO/SIO1 respectively. The throughput is doubled by an operation instruction taking advantage of the two IO pins in this fashion, compared to using just the input pin (SI) for instruction/address input and just the output pin (SO) for data/status output.

FIG. 1 shows an SPI interface configuration with a master integrated circuit device 110 electrically connected to slave integrated circuit devices 100, 101, and 102. The chip select pins of the master device 110 are CS#0, CS#1, and CS#2, and are electrically connected to the chip select CS# pin of the respective slave devices 100, 101, and 102. The serial clock (SCK) pin of the master device 110 is electrically connected to the serial clock (SCK) pin of the slave devices 100, 101, and 102. The master SI/SIO0 (MSI/SIO0) pin of the master device 110 is electrically connected to the SI/SIO0 pin of the slave devices 100, 101, and 102. The master SO/SIO1 (MSI/SIO1) pin of the master device 110 is electrically connected to the SO/SIO1 pin of the slave devices 100, 101, and 102. In this configuration, the MSIO0 and MSIO1 pins of the master integrated circuit device and the SI/SIO0 and SO/SIO1 pins of the slave integrated circuit devices are bi-directional input/output pins. During the instruction input phase, the MSIO1 and MSIO0 pins are regarded as output of the master, while the SI/SIO0 and SO/SIO1 pins are regarded as input of the specified slave. Conversely, during data output phase, the SI/SIO0 and SOSIO1 pins are regarded as the output of the particular slave; and the MSIO1 and MSIO0 pins are regarded as input of the master.

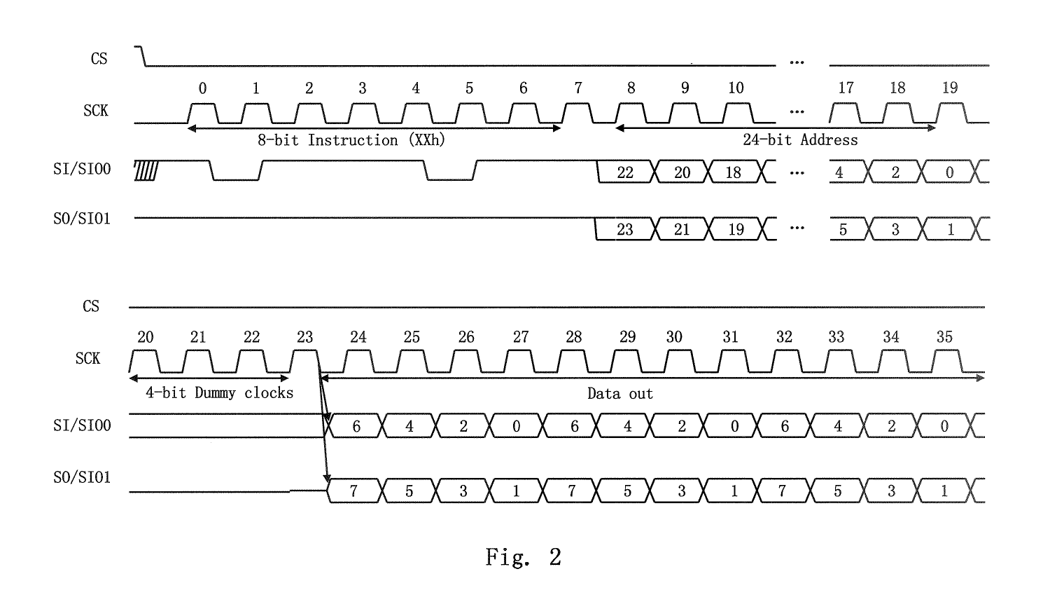

FIG. 2 shows an SPI integrated circuit timing diagram of a read operation with several dummy cycles to compensate for a delay in the slave integrated circuit.

After the device selecting signal (CS#) is asserted with a falling edge, an 8-bit instruction is transferred and received by SI to enable I/O operation of two pins in the same direction. The address is latched on rising/falling edges of SCK, and address data are shifted two bits at a time on the falling/rising edge of SCK, interleaved on 2 I/O pins, SI/SIO0 and SO/SIO1. The 1st and 2nd bit of addresses are transferred from MSIO0 and MSIO1 of the master device and received by SI/SIO0 and SO/SIO1 of the slave device simultaneously. Thus, address bit are communicated 2 bits at a time via SI/SIO0 and SO/SIO1 pins. Address bit continue to be transferred and received the same way until the 24-bit address transfer is complete. Based on the clock frequency of SCK, a certain number N=0, 0.5, 1, 1.5, 2, 2.5, etc., of dummy cycles can be inserted between the last bit of the address and the first bit of output data. The dummy cycle is used during internal operation of the slave device. For example, after a 4-bit dummy cycle is inserted, the data starts to shift out at falling/rising edge of SCK following the end of the dummy cycles. The data are shifted out 2 bits at a time by pins SO/SIO1 and SI/SIO0. The data of a byte can be shifted out in just a 4 clock falling/rising edge. The two bit output takes advantage of high data throughput enabled by using two pins of the SPI bus. Compared with a simpler SPI interface, this SPI interface has double data throughput and shorter address bit input time. A high throughput interface increases the system access time efficiency and improves overall system performance in the slave device operation duration.

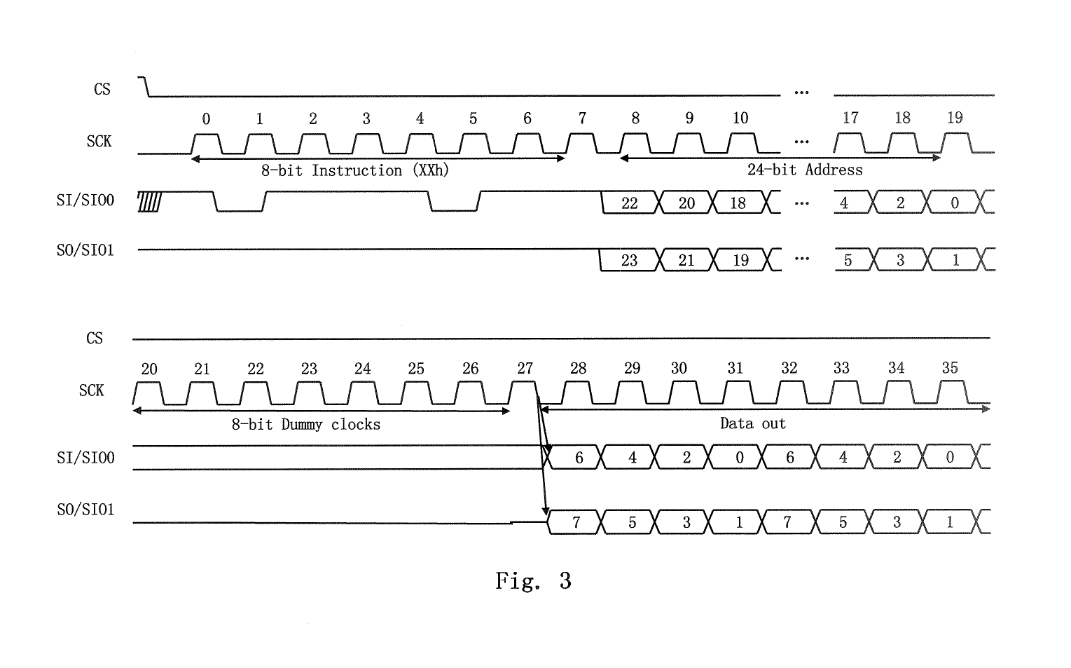

FIG. 3 shows an SPI integrated circuit timing diagram of a read operation with more dummy cycles than in FIG. 2 to compensate for a longer delay in the slave integrated circuit.

Shown is a data transfer with an 8-bit dummy clock cycle. A larger number of dummy cycles is needed to account for internal operation of the slave device, such as when internal operation of the slave device is slower, or when the SCK frequency is higher than the SCK frequency of an implementation associated with fewer dummy cycles, such as the 4-bit dummy cycle implementation of FIG. 2. The number of dummy cycles is dependent on the frequency of SCK. In other embodiments, a plurality of dummy cycles other than 8-bits is used, such as more than 8 bits or less than 8 bits.

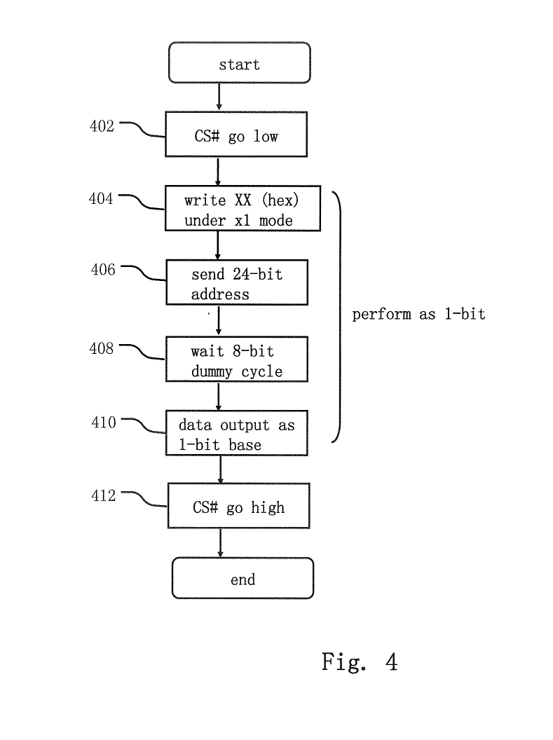

FIG. 4 shows a flow chart showing operation of an SPI integrated circuit in an operation mode using a single pin to communicate data.

In 402, CS# goes low. In 404, the READ instruction code is sent which is associated with the use of a single SPI pin to communicate data. In 406, the 24-bit address is sent on a single pin communicating data. In 408, waiting occurs for an 8-bit dummy cycle. In 410, data stored at the address is output on a single pin communicating data. In 412, CS# goes high, which can occur anytime during 410.

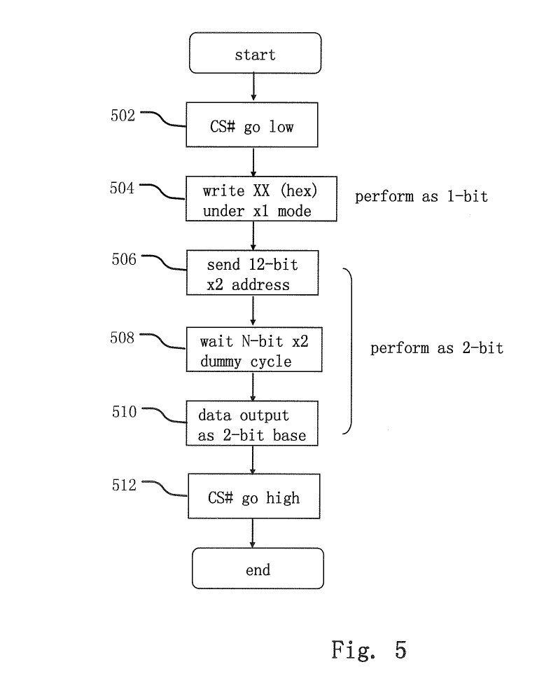

FIG. 5 shows a flow chart showing operation of an SPI integrated circuit in an operation mode using multiple pins to communicate data, and a number of dummy cycles after communicating the address and before communicating the data stored at the address.

In 502, CS# goes low. In 504, the READ instruction code is sent which is associated with the use of two SPI pins to communicate data. In 506, the 24-bit address is interleaved and sent on two pins communicating data. In 508, waiting occurs for an 8-bit dummy cycle. In 510, data stored at the address is output on two pins communicating data. In 512, CS# goes high, which can occur anytime during 510.

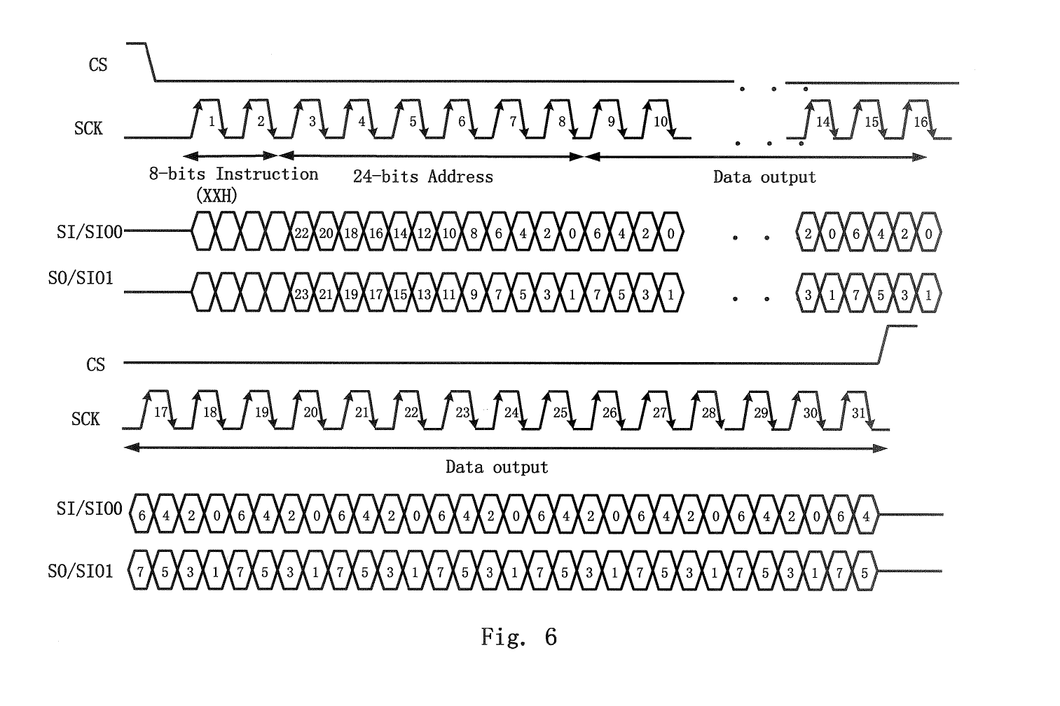

FIG. 6 shows an SPI integrated circuit timing diagram communicating data using multiple pins and at a DDR (double data rate).

Both the address sent from the master integrated circuit to the slave integrated circuit, and the retrieved data stored at the address sent back to the master integrated circuit from the slave integrated circuit, are communicated at a DDR. In both directions, two communication pins are used to interleave the data and thereby increase the speed. In another embodiment, a single pin communication pin is used rather than two communication pins.

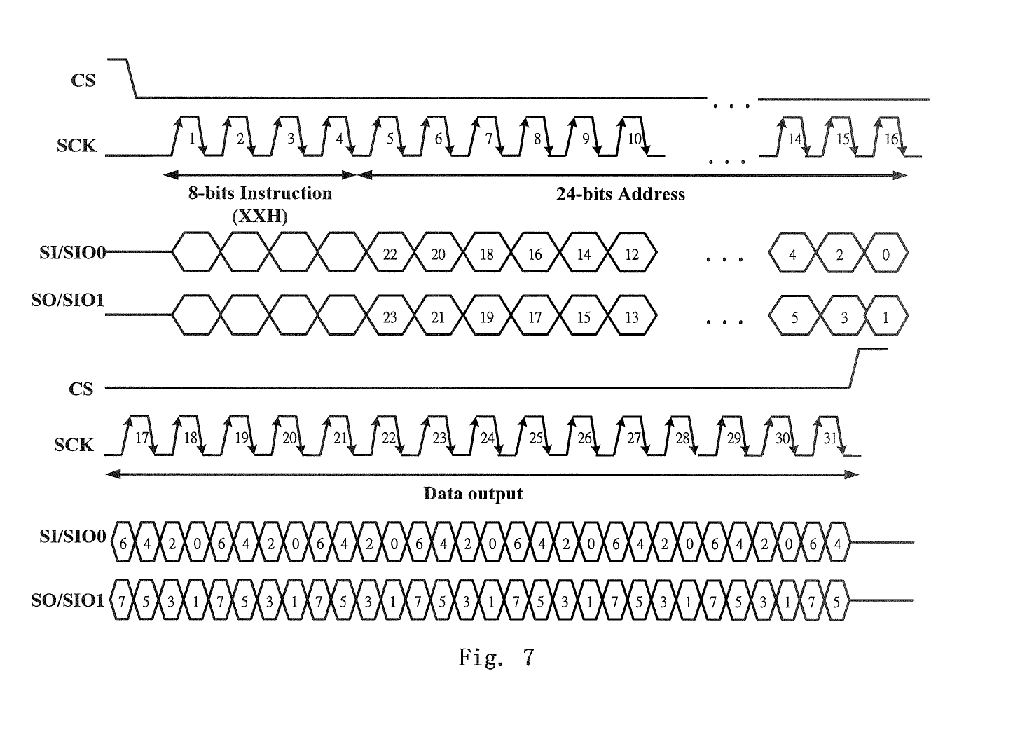

FIG. 7 shows an SPI integrated circuit timing diagram communicating data using multiple pins and at a DDR (double data rate) in one direction only between the master and slave.

The address sent from the master integrated circuit to the slave integrated circuit is not communicated at a DDR. The retrieved data stored at the address sent back to the master integrated circuit from the slave integrated circuit are communicated at a DDR. In both directions, two communication pins are used to interleave the data and thereby increase the speed. In another embodiment, a single pin communication pin is used rather than two communication pins.

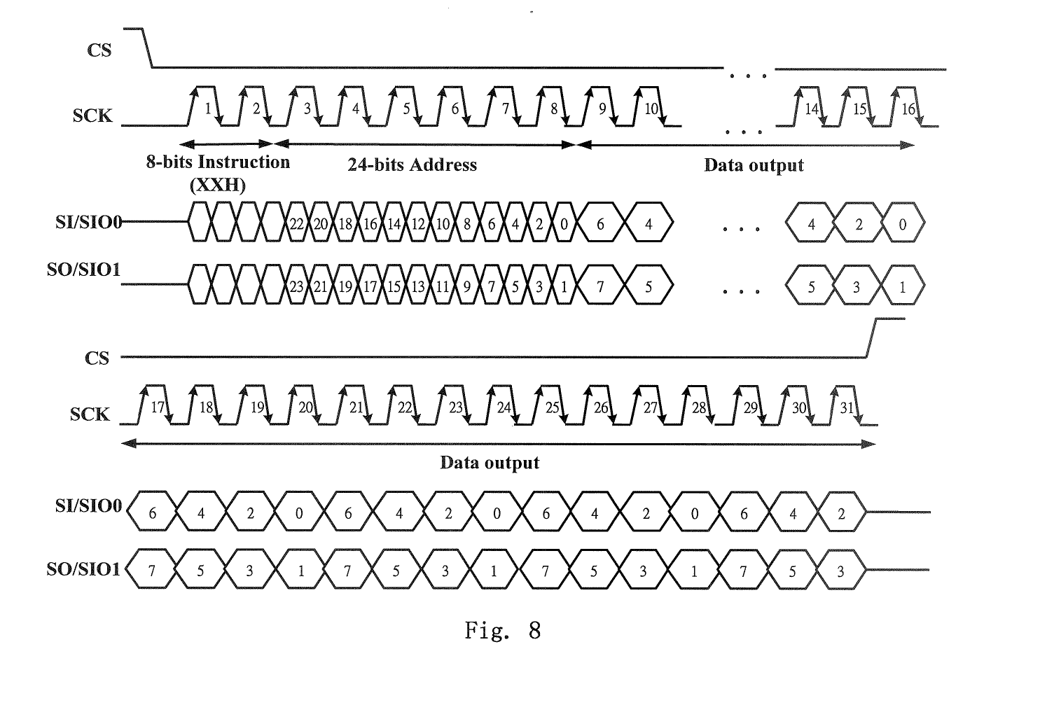

FIG. 8 shows an SPI integrated circuit timing diagram communicating data using multiple pins and at a DDR (double data rate) in one direction only between the master and slave, in particular the opposite direction from that of FIG. 7.

The address sent from the master integrated circuit to the slave integrated circuit is communicated at a DDR. The retrieved data stored at the address sent back to the master integrated circuit from the slave integrated circuit are not communicated at a DDR. In both directions, two communication pins are used to interleave the data and thereby increase the speed. In another embodiment, a single pin communication pin is used rather than two communication pins.

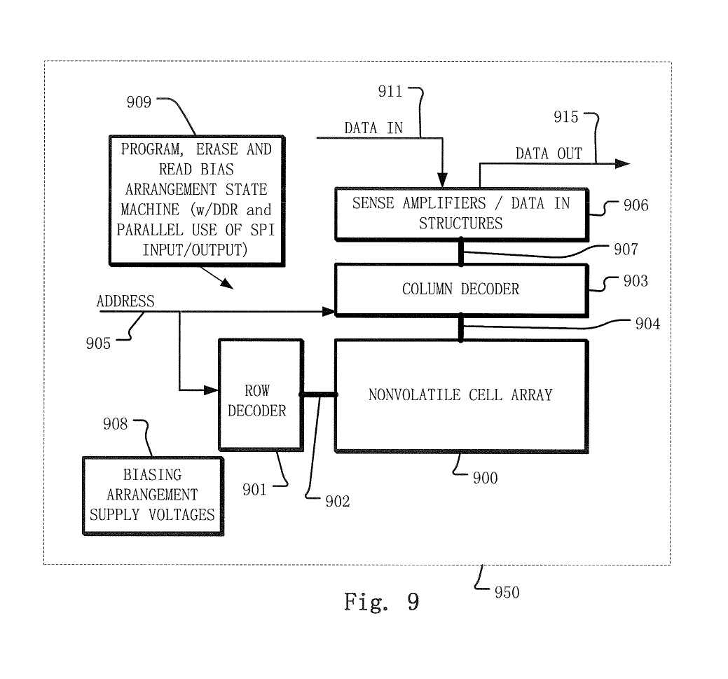

FIG. 9 shows an exemplary block diagram of an SPI integrated circuit that includes a nonvolatile memory array.

The integrated circuit 950 includes a memory array 900 implemented using nonvolatile memory cells, such as floating gate, charge trapping, or resistive element (e.g. phase change), on a semiconductor substrate. The memory cells of array 900 may be individual cells, interconnected in arrays, or interconnected in multiple arrays. A row decoder 901 is coupled to a plurality of word lines 902 arranged along rows in the memory array 900. A column decoder 903 is coupled to a plurality of bit lines 904 arranged along columns in the memory array 900. Addresses are supplied on bus 905 to column decoder 903 and row decoder 901. Sense amplifiers and data-in structures in block 906 are coupled to the column decoder 903 via data bus 907. Data is supplied via the data-in line 911 from input/output ports on the integrated circuit 950, or from other data sources internal or external to the integrated circuit 950, to the data-in structures in block 906. Data is supplied via the data-out line 915 from the sense amplifiers in block 906 to input/output ports on the integrated circuit 950, or to other data destinations internal or external to the integrated circuit 950. A bias arrangement state machine 909 controls the application of bias arrangement supply voltages 908, such as for the erase verify and program verify voltages, and the arrangements for programming, erasing, and reading the memory cells, such as with DDR timing and/or parallel interleaved use of two SPI communication pins.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. An integrated circuit comprising:
a bus following a Serial Peripheral Interface standard, the bus carrying data between the integrated circuit and another integrated circuit, comprising:
a plurality of pins, comprising:
a first data communication pin communicating the data over the bus;
a second data communication pin communicating the data over the bus;
a chip select pin indicating whether the data is being communicated between the integrated circuit and another integrated circuit; and
a clock pin;
wherein the bus operates in at least a first operation mode, in which the first data communication pin communicates data at a rate of one bit per half cycle of a clock signal.

2. The integrated circuit of claim 1, wherein the bus uses dummy cycles to compensate for a delay in another integrated circuit.

3. The integrated circuit of claim 1, further comprising:
a memory coupled to the bus.

4. The integrated circuit of claim 1, wherein the integrated circuit is a master integrated circuit.

5. The integrated circuit of claim 1, wherein the integrated circuit is a master integrated circuit, and the plurality of pins includes a plurality of chip select pins, each of the plurality of chip select pins indicating whether the data is being communicated between the master integrated circuit and a respective slave integrated circuit.

6. The integrated circuit of claim 1, wherein the integrated circuit is a slave integrated circuit.

7. The integrated circuit of claim 1, wherein the integrated circuit is a slave integrated circuit, and the chip select pin indicates whether the data is being communicated between the slave integrated circuit and a master integrated circuit.

8. The integrated circuit of claim 1, further comprising:
a mode control circuit for selectively operating in a plurality of operation modes, the plurality of operation modes comprising:
the first operation mode; and
a second operation mode, in which the first data communication pin communicates data at a rate of one bit per cycle of the clock signal.

9. The integrated circuit of claim 1, wherein in the first operation mode, the first data communication pin communicates data from the integrated circuit to another integrated circuit.

10. The integrated circuit of claim 1, wherein in the first operation mode, the first data communication pin communicates data to the integrated circuit from another integrated circuit.

11. The integrated circuit of claim 1, wherein in the first operation mode, the second data communication pin communicates data at a rate of one bit per half cycle of the clock signal.

12. The integrated circuit of claim 1, wherein in the first operation mode, the first data communication pin and the second data communication pin communicate data in a same direction between the integrated circuit and another integrated circuit.

13. A method of communicating data between integrated circuits, comprising:
clocking, via a clock pin, a bus following a Serial Peripheral Interface standard, the bus carrying data between an integrated circuit and another integrated circuit;
communicating a chip select signal indicating whether the data is being communicated between the integrated circuit and another integrated circuit;
communicating the data over a first data communication pin and a second data communication pin of the bus between the integrated circuit and another integrated circuit, wherein the first data communication pin operates at a rate of one bit per half cycle of a clock signal in at least a first operation mode.

14. The method of claim 13, wherein the bus uses dummy cycles to compensate for a delay in another integrated circuit.

15. The method of claim 13, further comprising:
communicating data with a memory coupled to the bus.

16. The method of claim 13, wherein the integrated circuit is a master integrated circuit.

17. The method of claim 13, wherein the integrated circuit is a master integrated circuit, and the plurality of pins includes a plurality of chip select pins, each of the plurality of chip select pins indicating whether the data is being communicated between the master integrated circuit and a respective slave integrated circuit.

18. The method of claim 13, wherein the integrated circuit is a slave integrated circuit.

19. The method of claim 13, wherein the integrated circuit is a slave integrated circuit, and the chip select pin indicates whether the data is being communicated between the slave integrated circuit and a master integrated circuit.

20. The method of claim 13, further comprising:
in a second operation mode, communicating data over the first data communication pin at a rate of one bit per cycle of the clock signal.

21. The method of claim 13, wherein in the first operation mode, the first data communication pin communicates data from the integrated circuit to another integrated circuit.

22. The method of claim 13, wherein in the first operation mode, the first data communication pin communicates data to the integrated circuit from another integrated circuit.

23. The method of claim 13, wherein in the first operation mode, the second data communication pin communicates data at a rate of one bit per half cycle of the clock signal.

24. The method of claim 13, wherein in the first operation mode, the first data communication pin and the second data communication pin communicate data in a same direction between the integrated circuit and another integrated circuit.

25. An apparatus communicating data between integrated circuits, comprising:
means for clocking a bus following a Serial Peripheral Interface standard, the bus carrying data between an integrated circuit and another integrated circuit;
means for communicating a chip select signal indicating whether the data is being communicated between the integrated circuit and another integrated circuit;
in a first mode of the bus, means for communicating the data over a first data communication pin of the bus and a second data communication pin of the bus between the integrated circuit and another integrated circuit, including:
means for communicating the data over the first data communication pin at a rate of one bit per half cycle of a clock signal.
